(19) United States
(12) Patent Application Publication
(10) Pub. No.: US 2004/0086678 A1
(43) Pub. Date: May 6, 2004

(54) Surface covering panel

(76) Inventors: Hao A. Chen, Chaddsford, PA (US); Nathan W. Easterday, Newark, DE (US)

Correspondence Address: KILYK & BOWERSOX, P.L.L.C., 53 A EAST LEE STREET, WARRENTON, VA, 20186, US

(21) Appl. No.: 10/697,532

(22) Filed: Oct. 30, 2003

Related U.S. Application Data
(60) Provisional application No. 60/423,096, filed on Nov. 1, 2002.

(51) Int. Cl. B32B 3/10

(52) U.S. Cl. 428/44; 428/166

(57) ABSTRACT

A surface covering is described wherein the surface covering includes at least one support surface, such as a core, with at least one base coating located on the support surface. The support surface preferably has a textured top surface. A printed pattern is located on the base coating and preferably the printed pattern is in register with the textured surface. At least one protective layer is located on the printed pattern. Methods of making the surface covering are further described.

This application claims the benefit under 35 U.S.C. § 119(e) of prior U.S. Provisional Patent Application No. 60/423,096 filed Nov. 1, 2002, which is incorporated in its entirety by reference herein.

### BACKGROUND OF THE INVENTION

The present invention relates to surface covering products, such as floor products, and methods of making the same. More particularly, the present invention relates to surface covering products which provide a unique appearance, such as highly detailed printed patterns on a textured surface.

There is a continuing effort in the surface covering industry to provide surface covering products, such as floor covering products, that have a more realistic appearance to better compete with other floor covering products that are available to consumers, such as ceramic, wood, stone, brick, marble, textile weave, and granite flooring, and the like. Various efforts have been made, such as those described in U.S. Pat. No. 6,114,008 and U.S. Pat. No. 5,961,903, wherein resilient vinyl floorings, for instance, were made having a very excellent natural appearance resembling the realistic appearance of true wood, stone, and the like. However, as with any industry, there is a continuing effort to improve upon successful products, such as the natural appearance products described in the above-identified patents. Accordingly, there is a need for surface coverings such as surface covering panels, having unique appearances not previously available and to further provide surface coverings that have even a more realistic, “natural look” or appearance of various commercially available natural products, such as hard wood surfaces, and the like.

One current approach to making floor covering with the “natural” appearance of tile or stone, for instance, involves the electronic registration of printed paper to an embossed plate and the alignment of the subsequent embossed panel to a cutting blade. The printed paper is placed over a rigid substrate which adds structural integrity to the print. The paper and substrate are aligned with electronic sensors in both the machine and cross machine directions with the engraved pattern of an embossed plate inside a press. The press is then closed and the paper and substrate fused into a single panel containing the surface texturing. The panel is then cooled for a set amount of time and then cut into individual planks of set size. Prior to being cut into the planks, the panel is again aligned with electronic sensors in both the machine and cross machine directions relative to the cutting blades. The purpose of this alignment is to allow for the printed and embossed grout to be cut in a way that leaves enough printed and embossed grout that when two subsequent planks are connected, a uniform grout joint is created. To use this technique, a minimum of $10 million USD is required for the retrofit of current press lines or the development of a new press line.

Along with the cost of such operations, it has been found that development of new surface textures is time consuming, taking up to six months in the engraving of the pressing plate, the determination of proper paper specifications regarding dimensional stability during printing and saturation, and the development of printing rolls so that the final print design after being impregnated will be in register with the engraved press plate. Due to the long lead time for the development of new embossing patterns, the pattern must already show an economically viable reason for producing the material, such as large customer demand. Small production runs are impractical using this method. The inflexibility of this method of producing floor covering also leads to limited design flexibility such as number of colors available to be used in printing, the pattern repeat length, and printing resolution of the gravure printing process.

Even if the above issues can be resolved, the registration tolerance of the finished product is so small that if the proper conditions during any of the preliminary steps is not properly maintained with accurate machine controls and operator attention, the print of the final product will not be aligned in register with the embossed regions of the plate. This not only produces a visual aberration but will make it impossible to cut the boards later in an assembly line fashion. Each panel would need to have the saw blades aligned prior to each panel being cut into individual planks.

Accordingly, there is a need to overcome these disadvantages.

### SUMMARY OF THE PRESENT INVENTION

A feature of the present invention is to provide a surface covering which has a simulated natural appearance of a hard wood surface or other natural surface.

Another feature of the present invention is to provide a surface covering that is in register with the embossed or textured design.

A further feature of the present invention is to provide a high resolution printed pattern on a surface covering panel.

A further feature of the present invention is to provide a sharper, deeper, more defined and detailed textured design.

A further feature of the present invention is to provide a sophisticated and delicate design, such as a mosaic with multiple colors, shades, and sizes which can include wood knots, distressed wood, and other variations found in natural surface products.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a surface covering panel which has a core, an optional base coating located on the core and having an embossed design, and a printed pattern located on the textured base coating and preferably in register with the embossed design. Preferably, at least one protective coating is located over the printed pattern. In the alternative or in combination with the base coating having an embossed design, the core can have an embossed design on its surface.

The present invention further relates to a method of making the surface covering panel of the present invention. The process involves providing at least one core; at least one base coating located on the core; and at least one printed pattern or decorative layer on the base coating; and preferably at least one protective layer located over the printed pattern. The present invention further involves embossing a surface texture on the surface of the core and/or base coating prior to providing the printed pattern.

It is to be understood that both the foregoing general description and the following detailed description are exemplary and explanatory only and are intended to provide a further explanation of the present invention, as claimed.

### BRIEF DESCRIPTION OF THE DRAWINGS

The accompanying drawings which are incorporated in and constitute a part of this application, illustrate various aspects of the present invention and together with the descriptions serve to explain the principals of the present invention.

The present invention will be described in greater detail with reference to the drawings in which:

FIGS. 1-5 depict a fragmentary, cross-sectional view of various embodiments of the surface covering of the present invention depicting the multiple layers in detail.

### DETAILED DESCRIPTION OF THE PRESENT INVENTION

In general, surface coverings and methods of making the same are provided by the present invention. The surface coverings of the present invention provide, in the preferred embodiment, a surface covering panel having a natural appearance, for instance, a hard wood surface appearance and thus provides surface coverings that have a realistic appearance as compared to other types of non-natural surface coverings. The surface covering panels of the present invention also, or in the alternative, in a preferred embodiment, have a surface texture which is in register with a printed pattern or design. For purposes of the present invention, surface covering includes, but is not limited to, flooring, such as modular tiles, in-laid floors, solid vinyl floors, resilient floors, homogeneous floors, cushioned floors, and the like; wallpaper, laminates, countertops, and other surfaces decorated by consumers. In a preferred embodiment, the surface covering panel is quite useful with laminate-type products.

In the present invention, in one embodiment, the surface covering has a backing layer or support surface. Preferably, the backing layer or support surface is at least one core. Examples of cores that can be used in the present invention include, but are not limited to, fiber board, particle board, recycled materials, agricultural based products, or other core materials used in the formation of laminate products, such as a number of layers of synthetic resin impregnated kraft paper and the like. The base layer or support layer can be a wood-based substrate. Other examples of suitable core material include, but are not limited to, polymer cores, such as thermoplastic or thermoset materials. Other examples include any surface that is capable of receiving a print layer and a base coat.

In the present invention, preferably, the surface covering panel has at least one backing layer or support surface, and at least one base coating located on the backing layer. The core(s) and/or the base coating(s) have a textured surface. This textured surface can be created by embossing the backing layer and/or the base coating on the backing layer. A printed pattern is located on the base coating and the printed pattern is preferably in register with the textured design. Preferably, at least one protective layer is located over the printed pattern.

As indicated, the backing layer, also known as the support surface or substrate layer, can be any conventional backing layer known to those skilled in the art. The thickness of the backing layer can be any suitable conventional thickness, such as from about 125 mils to about 480 mils or thicknesses above or below these ranges. Preferably, the thickness of a backing layer is from about 240 mils to about 320 mils, and more preferably about 310 mils.

Examples of suitable backing layers are flooring grade high density fiberboard (HDF) or medium density fiberboard (MDF) and other types of fiberboard and the like.

The base coating which is located on the backing layer is preferably a polymeric coating (e.g., thermoplastic or thermoset). Preferably, the base coating is a polyester based acrylic coating. Specific examples of the base coating include coating 142-0690 from L/T Technologies. The thickness of the base coating can be any suitable thickness, such as from about 1 to about 30 mils or thicknesses above or below these ranges. Preferably, the thickness of the base coating is from about 1 to about 10, and more preferably from about 2 to about 3 mils. In one embodiment, the base coating is optional, and the printed pattern can be located directly on the top surface of the backing layer.

Optionally, an adhesive base coat layer can be located on the top surface of the backing layer or core prior to the base coating described above. The adhesive base coat layer provides an improved surface for the base coat layer to be applied and adhered. The adhesive base coat layer can be any adhesive base coat layer capable of adhering to the top surface of the core or backing layer and provide a surface capable of retaining the base coating layer subsequently located above the adhesive base coat layer. Preferably, the adhesive base coat layer is a polyester based acrylic layer. A specific example of the adhesive base coat is product 122-0026-K from L/T Technologies. The adhesive base coat layer can have any suitable thickness such as from about 1 mil to about 10 mils (or thicknesses above or below this amount), and more preferably from about 2 mils to about 5 mils in thickness.

Furthermore, on the bottom surface of the core or backing layer can be located, as an option, a bottom balance layer. This bottom balance layer can further prevent any possible warping or curling of the panel. Any conventional bottom balance layer can be used, such as melamine impregnated kraft paper, polymeric coating, pre-pressed melamine kraft paper glued to the core or other layers that provide this balance function. A polymeric coating is preferred. A specific example of the polymeric coating bottom balance layer is polyester based acrylics, for instance, from L/T Technologies. The bottom balance layer further provides a moisture protection advantage. The bottom balance layer can have any suitable thickness, such as from about 1 mil to about 10 mils (or thicknesses above or below this amount), and more preferably from about 3 mils to about 5 mils. The bottom balance layer can be attached to the core by any means such as by an adhesive methods, such as, but not limited to, activation of melamine crosslinking during a high temperature and pressure pressing cycle, roll coating, air knife coating, spray coating and the like, and using an applied adhesive under high pressure on a preformed backer sheet.

The printed pattern or design located on the base coating can be any design or appearance. For instance, the printed design can have the appearance of a wood grain or can have the appearance of other natural surfaces. Also, the printed pattern can have the design of any other pattern desired by consumers. The printed pattern is preferably an inkjet printed pattern. In other words, the printed pattern is not a pattern printed on a paper or other substrate and then applied to the surface of the panel like conventional laminate manufacturing processes. In the present invention, preferably, the printed pattern is applied to the base coating or other surface with a printer which prints the pattern directly onto the base coating or other layer. Preferably, the printed pattern is an inkjet printed pattern. More preferably, the printed pattern is a digital inkjet printed pattern. When a textured design, such as an embossed design, is present on the backing layer and/or base coating, preferably, the printed pattern and the textured design are in register, and more preferably in register within about 1 mm or less. Furthermore, the printed pattern is applied after the textured design is present and thus the printed pattern exists over the textured design which provides a very realistic appearance. Furthermore, preferably, the printed pattern that is applied to the base coating or other surface has a resolution of at least 100 dpi and more preferably a resolution of from about 150 dpi to about 750 dpi or more. This permits a quite detailed appearance when desired. The printed pattern can be a single printed pattern or a series of printed patterns depending upon the ultimate appearance desired.

The digital print layer can have any thickness and preferably a thickness of from about 0.1 mil to about 10 mils or more, and more preferably from about 0.5 mil to about 3 mils. The digital print layer can typically be present on the panel in an amount of from about 1 g/m² to about 10 g/m² or more, and more preferably from about 4 to about 5 g/m² of ink present to form the digital print layer. Certainly, other amounts and thicknesses can be used depending upon desired uses.

In a preferred embodiment, at least one protective layer or coating is present over the printed surface covering panel to preferably protect the printed pattern or design. This protective coating can also be known as a wear layer topcoat. The protective layer can be any suitable material known for this purpose. Preferably, the protective layer is a radiation cured or thermally cured topcoat, such as epoxy acrylates, urethane acrylates, polyester acrylates, unsaturated polyester, or other reactive wear resistant polymers or other urethane containing layers. For instance, the top layer can be a hard thermoset UV-curable blend of acrylic or acrylate monomers having a glass transition temperature (Tg) of greater than 30° C.

Another example of a protective layer is a nano-composite topcoat layer. The nano-composite layer contains wear resistant particles such as aluminum oxide, silica or the like to provide a significantly improved resistance to wear. Preferably, the nano-composite layer is a nano-composite urethane topcoat layer, which contains an effective amount of aluminum oxide, silica or the like with an average particle size less then 1 micron, and more preferred between 20 and 200 nanometers, to provide wear resistance. Thus, the protective layer or coating can be one or more of the same or different layers and preferably has at least two layers. In one embodiment, one of the layers is a high gloss urethane topcoat layer which is the top most layer, and underneath the high gloss urethane topcoat layer is preferably the nano-composite urethane topcoat layer.

Preferably, the thickness of the protective layer can be any suitable thickness to adequately protect the printed pattern. Suitable thicknesses include from about 1 to about 10 mils or more. Preferably, the thickness of the protective layer is from about 0.5 to about 4 mils and, more preferably about 1 mil to 3 mils.

Other layers can be present in the surface covering panel, such as additional base coatings which are the same or different from the first base coating, additional protective layers, strengthening layers, reinforcement layers, and other layers, such as layers found in conventional laminate panels.

With respect to the surface covering panel, the panel can have any shape or size. Preferably, in one embodiment, the surface covering panel can have similar shapes and sizes to conventional laminate surface covering products. For instance, the surface covering panel in one embodiment can have a size of from about 4 inches to 70 inches in the machine direction and from about 4 inches to about 30 inches in the cross machine direction. Other sizes are possible depending on the production line used. The panel can have a total thickness of from about 0.2 to about 0.5 inch, (e.g., about 0.3 inch).

As indicated above, the surface covering panels of the present invention preferably have a textured design on the top surface of the backing layer or on the base coating which is located on the backing layer. Preferably, the textured design is on the base coating.

The surface covering panels or planks of the present invention can optionally have a tongue and/or groove design on the edges of the panels in order to install the panels to form a surface covering. The tongue and groove design can be a conventional non-mechanical locking system which can be connected by glue or other adhesives to the surface substrate and/or glued to each edge. Alternatively, the tongue and groove design can be a mechanical locking system designed for installation to form, for instance, a floating and/or glueless surface covering. Any interlocking system on the edges of the panels can be used in the present invention. Typically, if a tongue and groove design is used, two of the edges have a tongue design and the two remaining edges have a groove design.

Furthermore, in installing the floor, if a true grout look is desired, grout can be applied for purposes of cosmetic rather than structural reasons. Any standard grout or synthetic grout (e.g., acrylic, latex, or silicone) can be used for this purpose. In one advantage of the present invention, no grout or other cementitous under layer would be needed to hold the material to the floor.

In forming the products of the present invention, a core or other support surface is provided wherein a base coating is applied to the surface of the core. The textured design can then be created on the surface of the base coating. In the alternative, or in combination, a textured design can be created on the core prior to the application of the base coating. A printed pattern is then applied onto the base coating, which preferably is in register with any textured design present. At least one protective layer is then applied over the printed pattern to form the surface covering panel of the present invention.

In more detail, the support surface or core can be placed on a production line such as a conveyer belt wherein a base coating is applied onto the top surface of the core. The base coating can be applied by any standard application techniques used to apply a liquid onto the surface of a substrate such as by roll coating, spray coating, air knife, and the like. As an option, the support surface or core can be surface treated prior to the application of the base coating or the adhesive base coating if one is used. The surface treatment can be done in order to better promote adhesion of the adhesive base coat or the base coating. One way to surface treat the surface of the support surface or core is with a plasma jet. Other ways to surface treat include, but are not limited to, chemical and/or mechanical means such as, but not limited to, acid wash, solvent wash, sanding, wire screening or other surface roughening, and corona treatment. This surface treatment is particularly useful when the support surface or core is a cellulose-based surface such as a high density fiber board.

Generally, if a high density fiber board is used or other similar product, the boards will be cut to size in order to fit into the press used in the production line. The optional surface treatment can be done prior to or after any cutting of the boards used for the support surface or core.

As indicated, an adhesive base coat can be applied prior to the application of the base coating. If an adhesive base coat is applied, the application can be done using any standard application techniques used to apply a liquid onto the surface of a substrate such as by roll coating, spray coating, air knife, and the like. The thickness of the adhesive base coating, if used, can be from about 1 mil to about 10 mils or more, and more preferably from about 1 mil to about 3 mils. After the adhesive base coat is applied, the coating is dried or cured by standard conventional techniques, such as the use of an infrared heater oven or the like. A second coat or more coats of the adhesive base coat can be subsequently applied using the same techniques and/or the same coating thickness. Generally, if an infrared heater oven is used, the coating can be heated to above 40° C. for 10 to 30 seconds or more (e.g., from about 10 seconds to about 15 seconds) to dry or cure the coating. The base coating can then be applied using the same techniques.

Once the base coating is applied onto the core, the base coating is subjected to a drying or curing process in order to harden the base coating. Conventional drying or curing techniques can be used such as IR heater systems, convection oven systems, or the like.

As indicated above, the core or support surface and/or the base coating once applied can receive a textured design. The textured design can be applied by standard techniques such as by mechanical embossing and the like. The texture design is preferably applied onto the surface of the core and/or base coating by the use of a platen press or (an embossed roll). The platen press is used, which has a textured design on the plate surface, which is used to press the core and base coating. When using a press to create the texture design, a silicone release agent can be used with the press in order to avoid any of the base coat from sticking to the hot press plate. The texture design can be any design desired, such as the texture found in natural appearance products such as hardwood flooring and the like. The preferred process which involves the use of a platen press with a texture design on the surface of the upper plate of the platen press preferably is an engraved steel plate and this platen press is capable of forming a textured design which has an embossed depth of at least 1 mil and preferably from about 3 mils to about 50 mils or more. The embossed depth can be such that the textured design is formed on the base coating layer alone or on the core alone or on both the base coating and into the core. In this step, the platen press preferably has the following parameters: a platen press pressure of from about 435 psi (30 bar) to about 2175 psi (150 bar) or more and more preferably from about 500 psi (35 bar) to about 1090 psi (75 bar). The platen press preferably provides a platen press temperature of from about 150° C. to about 225° C. or more, and more preferably from about 180° C. to about 210° C. Preferably, the platen press at the above described processing conditions presses the product for a time of from about 6 seconds to about 30 seconds, and more preferably from about 12 seconds to about 18 seconds or a time sufficient to cause the embossing of the product.

Afterwards, the core containing the base coating receives a printed pattern or design. As indicated above, preferably, the printed pattern is applied with an ink printing technique which forms the printed pattern directly on the surface of the base coating. Preferably, the printed pattern is applied with the use of an inkjet printer and more preferably a digital inkjet printer. The printed pattern is preferably applied with the inkjet printer, which is preferably digital and is preferably in registered with the textured design, and more preferably in register within about 1 mm or less. Digital printer is capable of working with four colors or more such as cyan, magenta, yellow, and black, and has the capability of providing a detailed printed pattern with a resolution of at least 100 dpi in both the machine direction and cross machine direction or more, and more preferably from about 150 dpi to about 750 dpi. A digital printer is also capable of working with UV curable ink, organic solvent based ink, and waterborne based ink systems. The choice of ink will determine the type of curing system used. UV curable inks generally use UV lamps for curing while waterborne and organic solvent based inks use an infrared lamp to cure. Certainly, other curing techniques can be used which are known to those skilled in the art.

Preferably, with respect to the printed pattern, the ink placement preferably has a tolerance of about ±0.05 mm and a maximum position placement tolerance of ±0.1 mm.

Once the printed pattern is applied onto the base coating, at least one protective layer is preferably applied onto the printed pattern. The application of the protective layer can be applied in any fashion wherein a liquid is applied onto the surface of a substrate such as with the use of a roll coater, air knife, or sprayer, and the like. Preferably, the surface coating would have equivalent abrasion resistance to the current laminate overlay. As indicated above, one or more protective layers can be applied on the base coating. For instance, a low gloss or other gloss level nano-composite layer can be used and applied with an air knife or other coating technique. This coating can be subsequently dried or cured prior to the application of a second protective coating which is preferably a high gloss urethane coating as described above. By using a two layer system with different glosses, a contrasting or dual gloss coating can be achieved. Each of these coating can fully coat the entire surface of the base coating. Optionally, one of the coatings can partially overlap the other protective coating to provide a visual contrasting gloss. In this embodiment, the partial coating of one or both coatings can be in register to the printed pattern to highlight or dull certain patterns. This is quite effective in “natural” appearing products, like stone ceramic, brick, and the like. Thus, any combination of overlap is possible with respect to the protective layers especially if two or more are used.

Generally after each protective layer coating is applied, the coating will be dried or cured prior to the application of a subsequent coating.

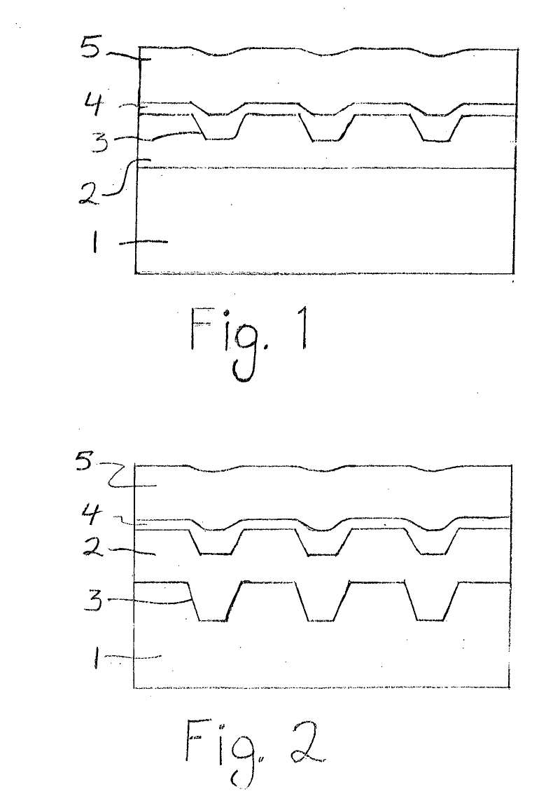

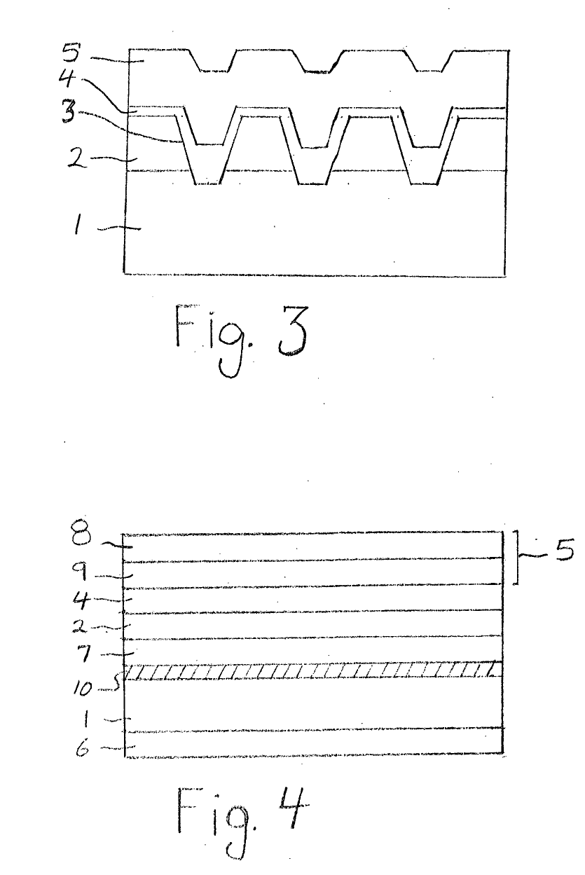

With respect to the figures, these figures are not to scale and are simply cross-sectional fragmentary views to show some of the embodiments of the present invention. With respect to FIG. 1, this figure represents one embodiment wherein the backing layer or support surface or core shown as 1 is the bottom layer and a base coating designated as 2 is located above core 1. The texturing or embossing is represented as 3, which in this embodiment is textured on the surface of the base coating 2. At least one printed pattern 4 is located above the base coating and is printed over the textured surface. The printed pattern can mimic the texture created or fully fill in the textured embossed patterned surface. At least one protective layer 5 is located above the printed pattern 4. With respect to FIG. 2, the numerals are the same as described above except in this embodiment, the core 1 has a textured surface which can then be reflected in the various coatings applied above such that the textured surface is eventually reflected on the top surface, i.e., the protective coating 5. FIG. 3 again represents the same layers as set forth in FIG. 1. In this embodiment, the textured surface 3 is a textured surface which is on and through the base coating 2 and into core 1. If there are any other layers located between core 1 and base coating 2, these layers would also be textured as well such as an adhesive base coat layer identified as 7 in FIG. 4.

With respect to FIG. 4, this figure represents the various other optional embodiments. Any one of these layers or all of the layers reflected in FIG. 4 can be used. The numerals previously discussed above with respect to FIG. 1 are the same layers in FIG. 4. An optional surface treatment of the core 1 can be done and this is identified as 10 in FIG. 4. An optional at least one adhesive base coat layer 7 can be located between core 1 and the base coating 2. The protective layer can comprise two or more layers such as a nano-composite urethane topcoat layer or other type layer identified as 9 along with a urethane topcoat layer identified as 8. The glosses of each of these layers can be the same or different depending upon desired appearance. A bottom balance layer identified as 6 can be also used and is located at the bottom surface of core 1.

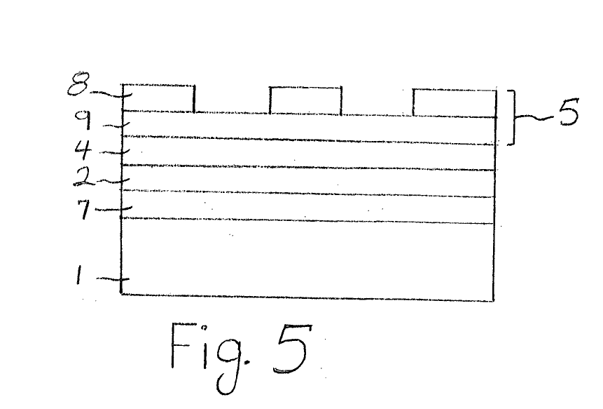

In FIG. 5, the same layers are represented by the same numerals as discussed for the previous figures. FIG. 5 shows an embodiment where the one of the protective layers 8 does not fully overlap protective layer 9 in order to create an optional contrasting gloss appearance. In FIGS. 4 and 5, embossing or textured surfaces are not shown to avoid any confusion but it is to be recognized that in FIGS. 4 and 5, any embossing as described earlier can be used such as the forming of a textured surface in core 1 or base coating 2 or both layers.

The surface covering panel of the present invention preferably has the following finished product properties. The abrasion resistance will be comparable to current laminate overlay. The product will be less sensitive to moisture, thus eliminating a common problem found among laminate flooring of cupping and crowning in the machine and cross machine directions. With digital inkjet printing, pattern changes of color, repeat length, and print resolution can be adjusted on a per run basis, adding much more flexibility than current methods. Smaller press sizes can be obtained, leading to cheaper press plates. This allows for a larger variety of textures to be developed cheaper and quicker than current methods.

With the present invention, the need to emboss in register is overcome by digitally printing on a pre-embossed surface. This is a significant advantage over conventional panels. In addition, the high resolution achieved by digitally printing is significantly better than conventional printing techniques such as with a rotogravure printing. Furthermore, the abrasion resistant layer which preferably contains a nano-composite material provides excellent abrasion resistance and wear. In addition, the surface of the panels of the present invention can be recoated with protective layers or other layers such as nano-composite layers to allow for rejuvenated appearance and wear resistance throughout the lifetime of the surface covering.

Other embodiments of the present invention will be apparent to those skilled in the art from consideration of the specification and practice of the invention disclosed herein. It is intended that the specification and examples be considered as exemplary only, with a true scope and spirit of the invention being indicated by the following claims and equivalents thereof.

What is claimed is:

1. A surface covering panel comprising:
at least one support layer with or without texturing; at least one base coating located on top of said support layer having a textured surface; at least one printed pattern located on said textured surface and in registered with said textured surface; and at least one protective layer located on the printed pattern.

2. The surface covering panel of claim 1, wherein said printed pattern is a digital printed pattern.

3. The surface covering panel of claim 1, wherein said printed pattern is a digital inkjet printed pattern.

4. The surface covering panel of claim 1, wherein said printed pattern and said textured design is in register to about 1 mm or less.

5. The surface covering panel of claim 1, wherein said textured design has an embossed depth of from about 3 mils to about 15 mils.

6. The surface covering panel of claim 1, wherein said textured design has an embossed depth of from about 1 mil to about 15 mils.

7. The surface covering panel of claim 1, wherein said printed pattern has a wood, tile, brick, ceramic, textile weave or stone pattern design.

8. The surface covering panel of claim 1, wherein said printed pattern has a resolution of at least about 100 dpi.

9. The surface covering panel of claim 1, wherein said printed pattern has a resolution of from about 150 dpi to about 750 dpi.

10. The surface covering panel of claim 1, wherein said support layer is a wood-based substrate.

11. The surface covering panel of claim 1, wherein said support layer comprises a polymer-based layer.

12. The surface covering panel of claim 1, wherein said support layer comprises particle board.

13. The surface covering panel of claim 1, wherein said base coating comprises a polymeric layer.

14. The surface covering panel of claim 1, wherein said at least one protective layer comprises a urethane top coat layer.

15. The surface covering panel of claim 1, wherein said support layer has a textured surface.

16. The surface covering panel of claim 1, wherein said support layer and said base coating have a textured surface.

17. The surface covering panel of claim 1, wherein said support layer comprises a wood and fiber board composite.

18. A method of making the surface covering panel of claim 1, wherein said method comprises applying at least one base coating onto a support surface;
applying a textured surface onto said base coating to form a textured surface; printing a pattern onto said textured surface; applying at least one protective coating onto said printed pattern; wherein said textured surface and said printed pattern are in register.

19. The method of claim 18, wherein said printing is accomplished with an inkjet printing system.

20. The method of claim 18, wherein said printing is accomplished with a digital inkjet printing system.

21. The method of claim 18, wherein said textured surface is created with a platen press or an embossed roll.

22. The method of claim 18, wherein said printing is at a resolution of at least 100 dpi.

23. The method of claim 18, wherein said printing is at a resolution of about 150 dpi to about 750 dpi.

24. The method of claim 18, further comprising applying at least one adhesive base coating prior to applying at least one base coating onto said support surface.

25. The method of claim 18 further comprising applying a bottom balance layer to the bottom surface of the said support surface.

26. The method of claim 18, wherein said support surface is surface treated prior to the application of at least one base coating.

27. The method of claim 18, wherein at least two protective coatings are applied.

28. The method of claim 27, wherein one protective coating is a nano-composite urethane topcoat layer and the other protective layer is a urethane topcoat layer, wherein each protective layer optionally has different gloss levels.

29. The method of claim 18, wherein said support layer has a textured surface.

30. A surface covering panel comprising:
at least one support layer having a textured surface; at least one base coating located on said support layer optionally having a textured surface; at least one printed pattern located on said textured surface and in registered with said textured surface; and at least one protective layer located on the printed pattern.

31. The surface covering panel of claim 1 further comprising at least one adhesive base coat located between said base coating and said support layer.

32. The surface covering panel of claim 1, wherein said support layer is a surface treated support layer.

33. The surface covering panel of claim 1, wherein said at least one protective layer comprises two protective layers.

34. The surface covering panel of claim 33, wherein one of the protective layers comprises a nano-composite urethane topcoat and the other protective layer comprises a urethane topcoat layer.

35. The surface covering panel of claim 33, wherein one of said protective layers comprises a low gloss nano-composite urethane topcoat layer and the other protective layer comprises a high gloss urethane topcoat layer.

36. The surface covering panel of claim 35, wherein said high gloss urethane topcoat layer is located on top of said nano-composite urethane topcoat layer.

37. The surface covering panel of claim 1, wherein said support layer comprises a high density fiber board.

38. The surface covering panel of claim 1, further comprising a bottom balance layer located on the bottom of said at least one support layer.

39. A surface covering panel comprising:
at least one support layer with texturing; optionally at least one base coating located on top of said support layer with or without a textured surface; at least one printed pattern located on said support layer or said textured surface and in registered with said texturing on said support layer; and at least one protective layer located on the printed pattern.
